(19) United States
(12) Patent Application Publication
(10) Pub. No.: US 2025/0384751 A1
(43) Pub. Date: Dec. 18, 2025

(54) SENSOR DEVICE AND SYSTEM BASED ON THE SENSOR DEVICE

(71) Applicant: Aware Buildings LLC, New York, NY (US)

(72) Inventor: Gerald KESTENBAUM, New York, NY (US)

(21) Appl. No.: 19/238,853

(22) Filed: Jun. 16, 2025

Related U.S. Application Data
(60) Provisional application No. 63/660,880, filed on Jun. 17, 2024.

(51) Int. Cl. G08B 19/00; G08B 1/08; G10L 25/51; G10L 25/72

(52) U.S. Cl. CPC G08B 19/00; G08B 1/08; G10L 25/51; G10L 25/72

(57) ABSTRACT

A method that detects a state in a facility with a sensor that has a non-transitory memory with sound samples recorded thereon, a microphone, and a processor that is configured to compare sounds received by the microphone to the sound samples, the method including receiving a sound from the microphone by the processor; comparing the sound with the sound samples; and generating a message by the processor in response to a determination that the received sound and a sound sample from the sound samples correspond.

### CROSS-REFERENCE TO RELATED APPLICATION AND CLAIM OF PRIORITY

The present application claims priority to U.S. Provisional Application Ser. No. 63/660,880, filed Jun. 17, 2024, the contents of which are incorporated by this reference.

### FIELD OF INVENTION

The present invention is concerned with a sensor that can receive audio signals from other sensors or sound sources, is configured to distinguish audio signals from different sensors and different sound sources based on learned audio signals, and is configured to generate a corresponding signal indicating that it has detected an audio signal from another sensor or another sound source.

### BACKGROUND

With the proliferation of awareness of different hazards of living in individual homes, but especially in multifamily residences, there has been equal proliferation of monitoring devices to minimize those risks. Prominent among them and mandated by many cities and counties are smoke detectors and carbon monoxide detectors.

The various detectors have different types of challenges, limitations, and requirements, both depending on the technology, and depending on the nature of the hazard. For example, sensor designers are very aware of the challenges of placement near electrical outlets and have designed sensors with minimal energy expectations so that they can run on batteries for an extended period of time.

One of the major limitations of sensors that are running on batteries is that they do not inform the residents that they've been triggered (when the resident is away) or that the battery is low. While there are some solutions that provide individual apps for individual owners, the technology for providing building-wide notification from battery-operated sensors is not easily available given that the usual methods of communication such as Bluetooth and WiFi do not cover a great range and other technologies such as WiFi and cellular often require significant battery consumption.

As a result, most buildings that do not have by code or through original construction, hardwired sensors do not actually monitor any of the sensors and rely upon a resident to report the state of the sensor. Hardwired often just means electrically hard-wired, not wired for reporting. So, even hardwired sensors often do not have a connection to a central fire panel or station.

This is obviously not optimal given that the resident may be sleeping or on vacation or the sensor may already have a dead battery.

In addition, even if a central monitoring in the learning technologies were available that was energy-efficient and suitable for use across a larger building, there are significant issues with communication in large buildings with LoRaWAN technology being one of the few that has been shown to be able to penetrate across a building. The overwhelming majority of sensors in the market are not compatible with LoRaWAN because this is a technology that the consumer is unable to implement and must be implemented and global-networked with proper gateways, etc.

Another challenge to having monitored sensors is that even if a technology did exist, the proliferation of the different types of sensors that are required based on conditions or local codes seem to be increasing, and each requires a different type of detection technology. So the costs of integrating built in technology for providing monitoring, alerting, and communication for the wide range of sensors that might be needed at the expense of each manufacturer and each product line separately would gradually become prohibitive and also somewhat of a challenge to work correctly and to troubleshoot. All of the benefits of the simplicity of the current generation of battery-operated sensors would disappear as they would need to become an army of wirelessly, communicating sensors with hardware, firmware and radio protocols of different types and brands. The current market is filled with many inexpensive products that coexist, and a universal way of establishing monitoring across the board for all devices would be desirous.

### SUMMARY OF THE INVENTION

In order to meet the needs of the market of non-communicating and limited power battery-operated sensors at scale in spaces that cover wide areas and multiple occupants (for example, an apartment complex), in a very simple way that does not require much maintenance or individual diligence, the following inventive sensor and sensor deployment are proposed.

A system and/or an apparatus according to the present invention includes a sensor with a microphone that is always on and that can be deployed in each apartment or kitchen or in building hallways. The microphone listens for sounds that are pre-trained/pre-recorded. The sensor is configured, based on the resident pre-trained sounds, to distinguish between smoke alarms, carbon monoxide alarms, natural gas sensor alarms, as well as those sensors that have no specific standard and are from different manufacturers, and implemented differently. For example, a majority of smoke alarm sensors generate three medium length beeps at 3.3 kilo hertz approximately, and then they repeat themselves. A large number of carbon monoxide sensors generate four very rapid beats/beeps and then repeat themselves. There is no beeping standard or frequency standard at all for natural gas sensors, of which some copy the carbon monoxide pattern, but provide slower beeps and some do something different entirely. The current invention relies on an audio training model, which can discriminate between the different output types of different sensor manufacturers, as well as the different conditions that they are alerting to. In addition to which, it is envisioned that additional alerts could be added to the model, such as detecting the sounds of prolonged dog barking, or listening for a pre-defined sound (like the call for “help” or rapid clapping five times) which could signal to the building staff, an emergency condition needing assistance, for example, in the event of a fall. The alarm extending device could also be used for cases related to health and safety, such as detecting the sounds of normal living, for example, frequency or absence of the sound of a toilet flushing.

If the inventive sensors are installed in hallways, they can also provide additional hall monitoring functionality for various types of noises that indicate disruptive activity and can also be equipped with Bluetooth or other beacon type of technology paired with Bluetooth reading technology to detect specific activity or object location information in the hallway such as, for example, helping to locate a luggage cart or helping to track delivery people to make sure that they are going to the authorized destinations.

A sensor according to the present invention can work off of LoRaWAN, which can be deployed building wide, and can also be used together with cellular or other technologies. Since the current invention is basically a listening device, it does not need to be mounted in any specific location in a room and can easily be plugged in conveniently to an outlet. Also, it can listen or do other types of sensing that requires more energy than what is provided by the batteries.

Various additional training for inputs on the fly can also be implemented with a sensor according to the present invention. In addition, the detection model can be updated on the fly. Moreover, various sequences of actions can be performed in response to the triggering of any of the notifications from the sensor.

A sensor according to the present invention extends both the reach and the scope of current battery-operated alarm technology. The reach because it can identify to the front desk of a building, for example, the event and the location of an alarm that is happening many floors away, and all hours of the day. The scope in that it allows adding for monitoring of other conditions that are best detected by audio machine learning rather than by the currently available and easily deployable battery-operated sensing. In the case of smoke detectors, a sensor according to the present invention allows for the identification of low-battery signals before the battery dies, thereby allowing central monitoring and implementing of battery replacements instead of finding out after a fire that the batteries died two years ago. This feature may be used for annual testing of the smoke detectors.

A method according to the present invention enables the detecting of a state in a facility (e.g. a residential building with multiple floors and units) with a sensor that has a non-transitory memory with sound samples recorded thereon, a microphone, and a processor that is configured to compare sounds received by the microphone to the sound samples, the method including receiving a sound from the microphone by the processor; comparing the sound with the sound samples; and generating a message by the processor in response to a determination that the received sound and a sound sample from the sound samples correspond.

The at least one of the sound samples may indicate an operational state of a device.

The device may be, for example, a smoke detector, a natural gas detector, or a carbon monoxide detector, and the sound sample, for example, indicates a low battery state or an alarm.

The at least one of the sound samples may be from a living sound source. The living sound source may be a canine, and the sound sample may indicate incessant barking, and/or the living sound source may be a human being, and the sound sample may indicate a request for assistance.

Another possible sound source may be a typical house sound such as the sound of a flushing toilet. A method according to the present invention could, for example, detect and keep track of how many times flushing toilet sounds are typically received and if it is determined to be unusually low or non-existent for a long period of time, a message could be sent by a system that implements a method according to the present invention to indicate that there may be something wrong. The message could be, for example, sent to an information system at the facility for action by a building manager, for example.

The sensor may include a transceiver, and the method further includes sending the message to a gateway in the facility that is operatively connected to a network.

The network may include a network server, and an information system at the facility in communication with the server, and further comprising sending the message to the network server, and receiving another message from the network server by the information system at the facility, the another message including information indicating that the sensor has determined that a received sound corresponds to at least one of the sound samples.

The method may further include including a copy of the received sound with the message.

The network may include a network server and an application server, and the method may further include receiving instruction by the processor from the application server via the network server and the gateway to delete at least one of the sound samples.

The network may include a network server and an application server, and the method may further include receiving by the processor another sound sample (from the application server, for example) and instruction from the application server via the network server and the gateway to add the another sound sample to the sound samples.

A method according to the present invention can be implemented to detect states in different zones of a facility with a plurality of sensors, each located in a respective zone of the zones of the facility, and each sensor having a non-transitory memory with sound samples recorded thereon, a microphone, and a processor that is configured to compare sounds received by the microphone to the sound samples, the method including receiving a sound from the microphone by the processor of one of the sensors; comparing the sound with the sound samples of the one of the sensors; and generating a message by the processor of the one of the sensors in response to a determination that the received sound and a sound sample from the sound samples correspond.

There may be a plurality of devices located within the facility, and the at least one of the sound samples in each sensor indicates an operational state of at least one of the devices in the facility.

The at least one of the sound samples may indicate a low battery state of, or an alarm from a smoke detector, a natural gas detector, or a carbon monoxide detector.

The at least one of the sound samples in each sensor may be from a living sound source.

The living sound source may be, for example, a canine, and the sound sample may indicate incessant barking.

The living sound source may be a human being, and the sound sample may indicate a request for assistance.

Each sensor may include a transceiver, and the method may further include sending the message from the one of the sensors to a gateway in the facility that is operatively connected to a network, the message indicating at least the zone associated with the one of the sensors, and information indicating that the received sound corresponds to at least one of the sound samples of the one of the sensors.

The network may include a network server, and an information system at the facility in communication with the server, and further comprising sending the message to the network server, and receiving another message from the network server by the information system at the facility, the another message including information indicating that the one of the sensors has determined that a received sound corresponds to at least one of the sound samples.

The message may include a copy of the received sound.

Other features and advantages of the present invention will become apparent from the following description of the invention which refers to the accompanying drawings.

### BRIEF DESCRIPTION OF THE DRAWINGS

FIG. 1 depicts a system that includes sensors according to the present invention in a facility.

FIG. 2 depicts components of a sensor according to the present invention.

### DETAILED DESCRIPTION OF EMBODIMENTS OF THE INVENTION

It is known that electronic devices such as sensors and actuators (end devices) can be connected to a network server to send at least information to the server.

LoRaWAN is a known protocol for implementing end device-to-server communication.

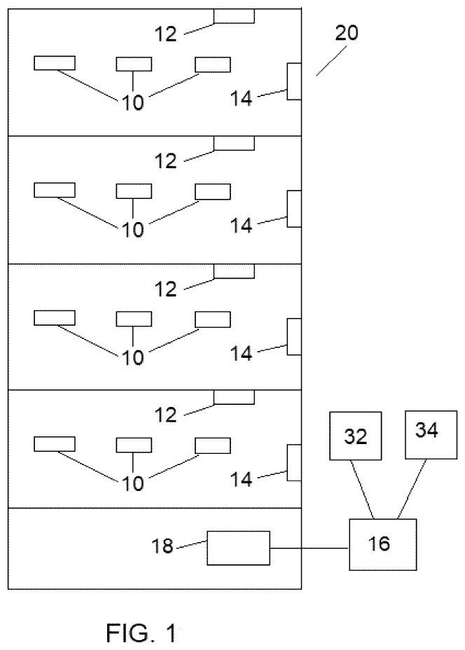

Referring to FIG. 1, a system that includes a sensor 12 or sensors 12 according to the present invention may be implemented on a LoRaWAN-based network that includes at least one sensor 12 or a plurality of sensors 12 according to the present invention, a gateway 14 or a plurality of gateways 14, and at least one network server 16.

A system according to the present invention is devised to service a building 20 having multiple sound sources 10. The sound sources 10 may include detectors such as smoke detectors, natural gas detectors, or carbon monoxide detectors. The sounds sources may be biological sources such as people, animals, or other objects such as a moving cart. The sensor 12 or the sensors 12 are trained to react to the output of the sound sources 10 as further explained below.

FIG. 1 depicts a multi-family, multi-floor, residential building 20, which is a preferred facility for a system according to the present invention, although other facilities could be furnished with a system according to the present invention.

Multiple sensors 12 may be deployed inside of the building 20. Each sensor 12 may be located in a different zone such as a different floor in the building 20. Each sensor 12 may be wirelessly connected to at least one gateway 14 to send modulated messages to the at least one gateway 14 or receive messages wirelessly via the at least one gateway 14. In the LoRaWAN network depicted in FIG. 1, the sensors 12 can be battery operated or not, but are preferably battery-operated.

The gateways 14 forward the messages from the sensors 12 to the network server 16. Gateways 14 may communicate with the server 16 using a cellular signal (3G/4G/5G), a WiFi, Ethernet, fiber-optic, or 2.4 GHz radio communication.

The gateways 14 may be indoor (picocell) gateways and outdoor gateways (macrocell).

The indoor gateways can cover deep indoor locations like hallways or basements inside of a multi-floor building. The indoor gateways have internal or external antennas and can be plugged into the AC power outlet.

The outdoor gateways can cover a wider area than the indoor gateways in rural or urban areas. The outdoor gateways can be mounted on towers, building roof tops, and so on. An outdoor gateway may have an external antenna connected with a coaxial cable.

The network server 16 may be a computer (e.g. a PC) which has stored thereon a software that manages the network of the sensors 12 and the gateways 14.

The network server 16 may also have stored thereon software for securely processing the data.

The network server 16 may also have stored thereon software to process join-request messages sent by the sensors 12.

The LoRaWAN network depicted in FIG. 1 may have an application server 32 that receives application-specific messages from the sensors 12 via the network server 16, and sends application-related messages to the sensors 12 via the network server 16. There can be more than one application server 32 in the network.

The LoRaWAN network shown in FIG. 1 may also have a join server 34 to perform tasks related to device activation, root key storage, and session key generation. A sensor 12 may start the joining process by sending a join request message to the join server 34 through the network server 16. The join server 34 then processes the join request, generates session keys, and transfers NwkSKey and AppSKey to the network server 16 and the application server 32 respectively. The NwkSkey (Network Session Key) enables interaction between the sensors 12 and the network server 16. The AppSKey (Application Session Key) is used to encrypt and decrypt the message.

The sensors 12 may communicate with all gateways 14 that are within the communication range of the sensors 12, or each sensor 12 may be configured to communication with a specific gateway 14 or specific (not all) gateways 14. Each sensor 12 within the network may be associated with a unique identifier (e.g. a number), which can be used to identify its location within the facility

The network server 16 may be in communication with a local information system 18, which has at least one computer with a monitor to display messages received from the network server 16 that pertain to the information sensed by the sensors 12. A message concerning information detected by a sensor 12 may include the nature of the information received (e.g. the sound that was detected), and the location from which the information was collected, which is extrapolated from the identifier of the sensor 12 that collected the information.

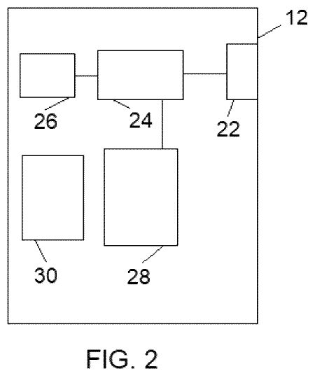

Referring to FIG. 2, a sensor 12 according to the present invention includes at least a microphone 22, a programmed processor 24, a transceiver 26, a non-transitory memory 28 that can be read and written on by the processor 24, and a battery 30.

The processor 24 sends messages to and receives messages from the application server 32 via the transceiver 26.

The memory 28 has stored thereon sound samples in digital form and in a non-transitory manner. The electronic samples of the various sounds may be loaded onto the memory 28 or deleted from the memory 28 by the processor in response, for example, to an instruction received from the application server 32. Alternatively, the transceiver 26 may be a Bluetooth® transceiver and the data updates may be carried out via a Bluetooth® connection with a Bluetooth® device. Thus, the sensor 12 may be programmed (loaded) with various sound samples. A sound sample as used in this application is not limited to a file format that allow for audio reproduced by a digital player such as an MP3 file, but includes any digital file that characterizes a particular sound for comparison with sounds received by the sensor as described herein.

The processor 24 may be used to read the sound samples from the memory 28, and, on instruction received from the application server 32, to store a sound sample onto the memory 28, or delete a sound sample from the memory 28. The battery 30 may provide power to the processor 24, the memory 28, and the transceiver 26.

A sensor 12 according to the present invention basically operates to collect sounds from its surroundings (which includes the sounds from the sound sources 10) via the microphone 22, compares each received sound to the sounds stored in the memory 28, and in response to determining that the received sound corresponds to (matches) a stored sound, sends a message to the application server 32. Specifically, an analog signal received by the processor 24 from the microphone 22 is converted to a digital signal, and the processor 24 is programmed to compare the digital signal to the stored sound sample in memory 28. The message that is sent by the processor 24 may include the unique identifier for the transmitting sensor, and an information identifying the sound that was detected, which may be, for example, a code, or a copy of the sound that was detected. The application server 32 then sends a message to the information system 18 via the network sever as previously described.

According to the present invention, each sound sample is an indicator of a particular state. For example, a sound sample may be the sound generated by a smoke detector or a gas detector that indicates the detector is low on battery. A sound sample may indicate an emergency state. The sound of a dog barking non-stop, the sound of a person asking for help, loud banging sounds indicative of possible altercations, are possible examples.

A system according to the present is not limited to emergency uses. The sensors 12 may be used for periodic testing. For example, residents of the building 20 may be asked to press a test button of a smoke detector so that a nearby sensor 12 can detect whether a proper sound is being generated by the detector or not.

As is clear from the present description the programmable nature of a sensor 12 according to the present invention permits the sensor 12 to be customized (configured) for a variety of different sounds, which allows the sensor 12 to be used with different brands of detectors that make different sounds indicating a particular operational state (e.g. low battery state).

To determine correspondence between the received sound and a sound sample, any method used for sound or speech recognition could be used. A non-exhaustive list includes simple pattern matching, pattern and feature analysis, language modeling and statistical analysis, or using an artificial neural network. The processor 24 of a sensor 12 according to the present invention is configured (programmed) to execute the method for determining correspondence.

Although the present invention has been described in relation to particular embodiments thereof, many other variations and modifications and other uses will become apparent to those skilled in the art. It is preferred, therefore, that the present invention be limited not by the specific disclosure herein, but only by the appended claims.

What is claimed is:

1. A method of detecting a state in a facility with a sensor that has a non-transitory memory with sound samples recorded thereon, a microphone, and a processor that is configured to compare sounds received by the microphone to the sound samples, the method comprising:
receiving a sound from the microphone by the processor;
comparing the sound with the sound samples; and
generating a message by the processor in response to a determination that the received sound and a sound sample from the sound samples correspond.

2. The method of claim 1, wherein at least one of the sound samples indicates an operational state of a device.

3. The method of claim 2, wherein the device is a smoke detector, a gas detector, or a carbon monoxide detector, and wherein the sound sample indicates a low battery state or an alarm.

4. The method of claim 1, wherein at least one of the sound samples is from a living sound source.

5. The method of claim 4, wherein the living sound source is a canine, and the sound sample indicates incessant barking.

6. The method of claim 4, wherein the living sound source is a human being, and the sound sample indicates a request for assistance.

7. The method of claim 1, wherein the sensor comprises a transceiver, and further comprising sending the message to a gateway in the facility that is operatively connected to a network.

8. The method of claim 7, wherein the network includes a network server, and an information system at the facility in communication with the server, and further comprising sending the message to the network server, and receiving another message from the network server by the information system at the facility, the another message including information indicating that the sensor has determined that a received sound corresponds to at least one of the sound samples.

9. The method of claim 8, further comprising including a copy of the received sound with the message.

10. The method of claim 7, wherein the network includes a network server and an application server, and further comprising receiving instruction by the processor from the application server via the network server and the gateway to delete at least one of the sound samples.

11. The method of claim 7, wherein the network includes a network server and an application server, and further comprising receiving by the processor another sound sample and instruction from the application server via the network server and the gateway to add the another sound sample to the sound samples.

12. A method of detecting states in different zones of a facility with a plurality of sensors, each located in a respective zone of the zones of the facility, and each sensor having a non-transitory memory with sound samples recorded thereon, a microphone, and a processor that is configured to compare sounds received by the microphone to the sound samples, the method comprising:
receiving a sound from the microphone by the processor of one of the sensors;
comparing the sound with the sound samples of the one of the sensors; and
generating a message by the processor of the one of the sensors in response to a determination that the received sound and a sound sample from the sound samples correspond.

13. The method of claim 12, wherein there are a plurality of devices located within the facility, and wherein at least one of the sound samples in each sensor indicates an operational state of at least one of the devices in the facility.

14. The method of claim 13, wherein the at least one of the sound samples indicates a low battery state of or an alarm from a smoke detector, a natural al gas detector, or a carbon monoxide detector.

15. The method of claim 12, wherein at least one of the sound samples in each sensor is from a living sound source.

16. The method of claim 15, wherein the living sound source is a canine, and the sound sample indicates incessant barking.

17. The method of claim 15, wherein the living sound source is a human being, and the sound sample indicates a request for assistance.

18. The method of claim 12, wherein each sensor comprises a transceiver, and further comprising sending the message from the one of the sensors to a gateway in the facility that is operatively connected to a network, the message indicating at least the zone associated with the one of the sensors, and information indicating that the received sound corresponds to at least one of the sound samples of the one of the sensors.

19. The method of claim 18, wherein the network includes a network server, and an information system at the facility in communication with the server, and further comprising sending the message to the network server, and receiving another message from the network server by the information system at the facility, the another message including information indicating that the one of the sensors has determined that a received sound corresponds to at least one of the sound samples.

20. The method of claim 19, wherein the message includes a copy of the received sound.
